(19) United States
(12) Patent Application Publication
(10) Pub. No.: US 2024/0079730 A1
(43) Pub. Date: Mar. 7, 2024

(54) BUSBAR SHROUD FOR A TRACTION BATTERY AND BUSBAR PROTECTION METHOD UTILIZING A SHROUD

(71) Applicant: Ford Global Technologies, LLC, Dearborn, MI (US)

(72) Inventor: Micah Smith, Detroit, MI (US)

(21) Appl. No.: 18/163,903

(22) Filed: Feb. 3, 2023

(51) Int. Cl. H01M 50/507; B60L 50/60; B60L 50/64; H01M 50/526

(52) U.S. Cl. CPC H01M 50/507; B60L 50/64; B60L 50/66; H01M 50/526; H01M 2220/20

(57) ABSTRACT

A traction battery assembly includes a shroud providing a channel that receives at least one busbar, and a plug that engages the shroud to brace the shroud. A traction battery busbar protection method includes positioning a least one busbar within a channel of shroud, and after the positioning, bracing the shroud with a plug that engages the shroud.

### TECHNICAL FIELD

This disclosure relates generally to a shroud that provides a channel to receive a busbar within a traction battery pack and, more particularly, to using the shroud together with a plug that engages the shroud to brace the shroud.

### BACKGROUND

A traction battery pack of an electrified vehicle can include groups of battery cells arranged in one or more cell stacks. The battery cells can include terminals that are typically electrically connected to other terminals, a busbar, or both.

### SUMMARY

In some aspects, the techniques described herein relate to a traction battery assembly, including: a shroud providing a channel that receives at least one busbar; and a plug that engages the shroud to brace the shroud.

In some aspects, the techniques described herein relate to a traction battery assembly, wherein the shroud has a U-shaped cross-sectional profile.

In some aspects, the techniques described herein relate to a traction battery assembly, wherein the shroud is an extruded shroud.

In some aspects, the techniques described herein relate to a traction battery assembly, wherein the shroud includes a plurality of longitudinally extending ribs configured to retain the plug.

In some aspects, the techniques described herein relate to a traction battery assembly, wherein the shroud is an aluminum shroud.

In some aspects, the techniques described herein relate to a traction battery assembly, wherein the shroud is disposed between a first cell stack and a second cell stack.

In some aspects, the techniques described herein relate to a traction battery assembly, wherein the at least one busbar includes and electrically isolating coating.

In some aspects, the techniques described herein relate to a traction battery assembly, further including a traction battery pack enclosure that holds the shroud and the plug.

In some aspects, the techniques described herein relate to a traction battery assembly, wherein the shroud extends longitudinally in a direction aligned with a longitudinal axis of an electrified vehicle.

In some aspects, the techniques described herein relate to a traction battery assembly, wherein the plug is press-fit to the shroud to engage the shroud.

In some aspects, the techniques described herein relate to a traction battery assembly, wherein the plug includes a plurality of ribs configured to engage with corresponding ribs of the shroud.

In some aspects, the techniques described herein relate to a traction battery assembly, wherein the plug is an extruded plug.

In some aspects, the techniques described herein relate to a traction battery assembly, wherein the plug and the shroud are the same material.

In some aspects, the techniques described herein relate to a traction battery assembly, wherein the plug and the shroud are both aluminum.

In some aspects, the techniques described herein relate to a traction battery assembly, wherein the plug includes an inserted portion that is configured to be inserted in a direction D into the channel, wherein a ratio of a height of the inserted portion to a width of the inserted portion is greater than 0.5.

In some aspects, the techniques described herein relate to a traction battery assembly, wherein the plug has a height and a width, the height corresponding to the direction D.

In some aspects, the techniques described herein relate to a traction battery busbar protection method, including: positioning a least one busbar within a channel of shroud; and after the positioning, bracing the shroud with a plug that engages the shroud.

In some aspects, the techniques described herein relate to a traction battery busbar protection method, wherein the shroud is a U-shaped shroud.

In some aspects, the techniques described herein relate to a traction battery busbar protection method, further including engaging the shroud by press-fitting the plug to the channel.

In some aspects, the techniques described herein relate to a traction battery busbar protection method, wherein the plug is at least partially received within the channel.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates an expanded view of a shroud, a plurality of busbars, and a plug from the traction battery pack of FIG. 2.

FIG. 4 illustrates a perspective view of the shroud, the busbars, and the plug when partially assembled.

FIG. 5 illustrates a section view taken at line 5-5 in FIG. 4.

FIG. 6 illustrates a side view of the plug in FIG. 3.

### DETAILED DESCRIPTION

This disclosure details a shroud and plug engaged with each other to enclose at least one busbar of a traction battery pack. The shroud and plug can help to protect and electrically isolate the at least one busbar. The plug can additionally brace the shroud thereby helping to prevent the shroud from compressing the at least one busbar when forces are applied to the shroud.

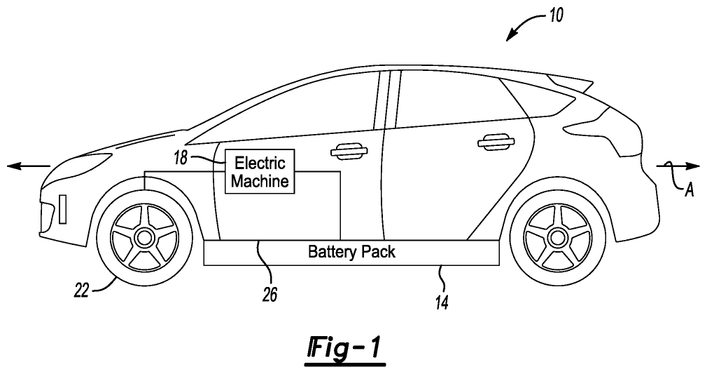

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

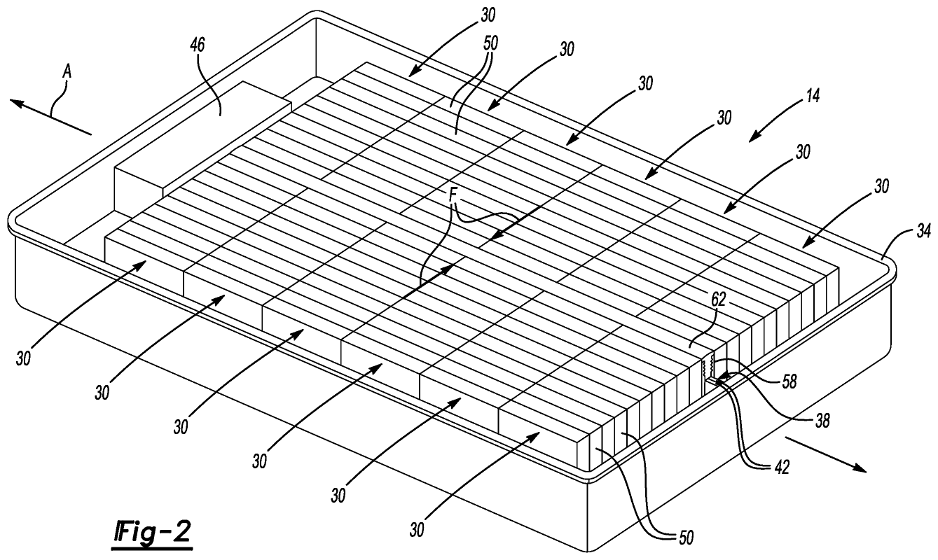

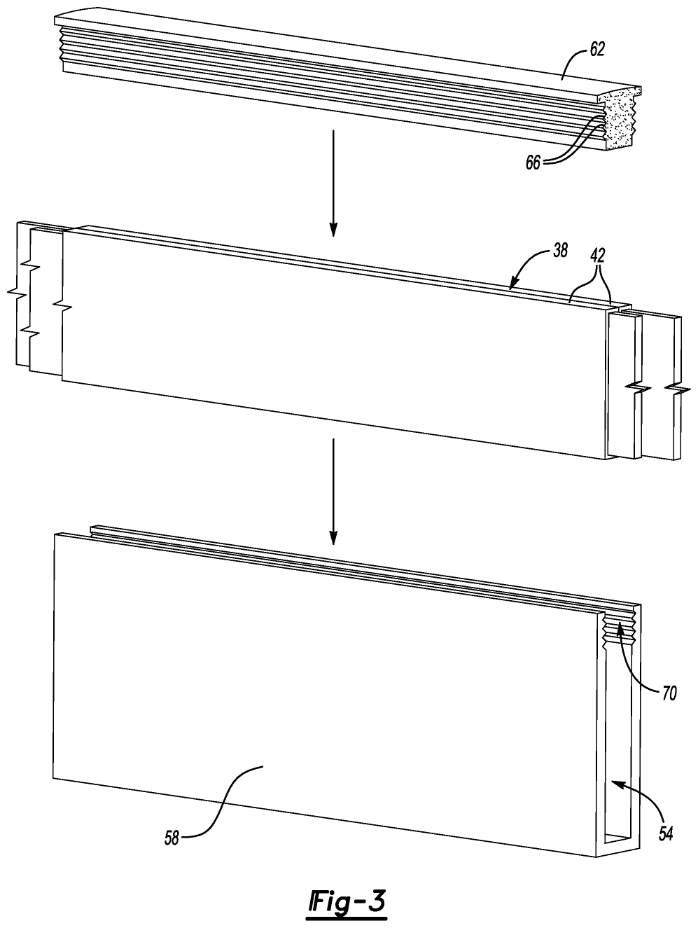

With reference now to FIGS. 2-5 and continuing reference to FIG. 1, the battery pack 14 includes a plurality of cell stacks 30 held within an enclosure 34. A cover of the enclosure 34 is not shown in FIG. 2 so that an interior of the enclosure 34 can be viewed.

A busbar assembly 38 extends longitudinally through the traction battery pack 14. The busbar assembly 38 includes, in this example, two individual busbars 42. The busbars 42 can distribute electric power within the battery pack 14. In this example, the busbars 42 convey electric power between the cell stacks 30 and a contactor module 46 of the battery pack 14.

The busbars 42 are packaged within the enclosure 34 such that the busbars 42 are positioned laterally between six cell stacks 30 on a driver side of the battery pack 14 and six cell stacks 30 on a passenger side of the battery pack 14. Each of the twelve total cell stacks 30 includes ten individual battery cells 50. Other numbers of battery cells 50 and cell stacks 30 could be utilized in other examples.

Over time, battery cells 50 can expand, which can exert forces F that, if not addressed, can compress the busbars 42 between cell stacks 30 on the driver side and cell stacks 30 on the passenger side.

To help shield the busbars 42 from the forces F, the busbars 42 are received within a channel 54 of a shroud 58. The shroud 58 can be an extruded metal or metal-alloy. In a specific example, the shroud 58 is an aluminum shroud.

A person having skill in this art and the benefit of this disclosure could understand how to structurally distinguish an extruded structure from a structure that is not extruded, such as a structure that is cast. Thus, specifying that the shroud 58 is an extruded shroud implicates structure to the shroud 58 and structurally distinguishes the shroud 58 from shrouds that are not extruded.

The shroud 58 can resist the forces F and block the forces F from being applied to the busbars 42. Generally, the shroud 58 has a U-shaped cross-sectional profile that provides the channel 54. During assembly, the busbars 42 can be moved into the channel 54 through the open side of the channel 54.

After the busbars 42 are received within the channel 54, the plug 62 engages the shroud 58. The plug 62 reinforces the shroud 58 helping to prevent the shroud 58 from flexing inward against the busbars 42 in response to the forces F.

The plug 62, in this example, is at least partially received within the channel 54 when engaging the shroud 58. Like the shroud 58, the plug can be a metal or a metal-alloy, and, in this example the plug 62 is an aluminum plug. The plug 62 can be an extruded plug, which, like the shroud 58 is a structural distinction that could be ascertained by a person having skill in this art to structurally distinguish the plug 62 from structures that are not extruded.

When assembled within the vehicle 10, the busbars 42, the shroud 58, and plug 62, extend fore and aft. That is, the busbars 42, the shroud 58, and plug 62 extend longitudinally in a direction aligned with a longitudinal axis A of the vehicle 10.

The plug 62 can, along the sides of the plug 62, include a series of ribs 66 extending longitudinally with the remaining portions of the plug 62. Similarly, the shroud 58 can include a series of ribs 70 along the sides of the channel 54 that interface with the plug 62 when the plug 62 engages the shroud 58. Although the plug 62 and the shroud 58 both include ribs in this example, other examples may include the ribs 66 but not the ribs 70, or vice versa.

To engage the plug 62 with the shroud 58, the example plug 62 is press-fit into the channel 54 of the shroud 58. The ribs 66 and the ribs 70 interface directly with each other to establish and interference fit and resist withdrawal of the plug 62 after press-fitting the plug 62 into the channel 54. The ribs 66 and 70 thus help to retain the plug 62 within the channel 54 and in an engaged position with the shroud 58

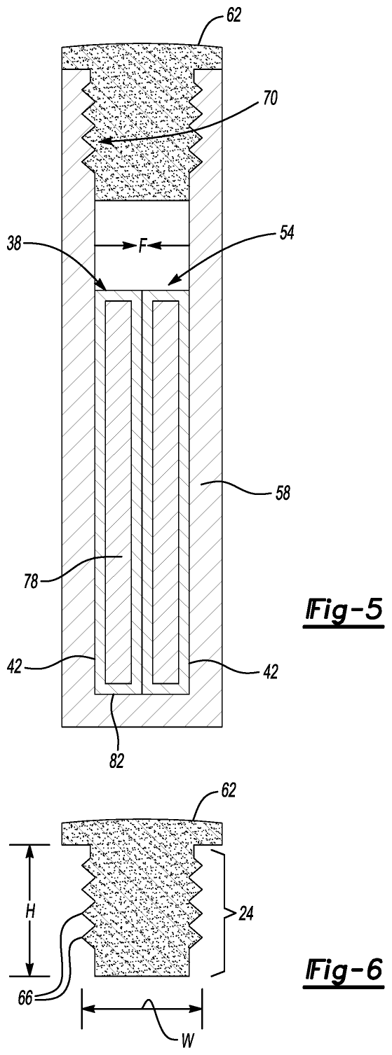

The plug 62, when engaged with the shroud 58, helps to resist the sides of the shroud 58 from folding inward and compressing against the busbars 42 within the channel 54. That is, as shown in FIG. 5, the plug 62 resists movement of the walls of the shroud 58 from folding inward along paths F, which could undesirably compress the busbars 42 that are within the channel 54.

The shroud 58 and the plug 62, when engaged, substantially enclose the busbars 42 within the channel 54. This can desirably protect the busbars 42.

The busbars 42 in this example, with reference to FIG. 5, include a copper interior 78, which is coated with an electrically isolating coating 82, such as a polymer-based coating.

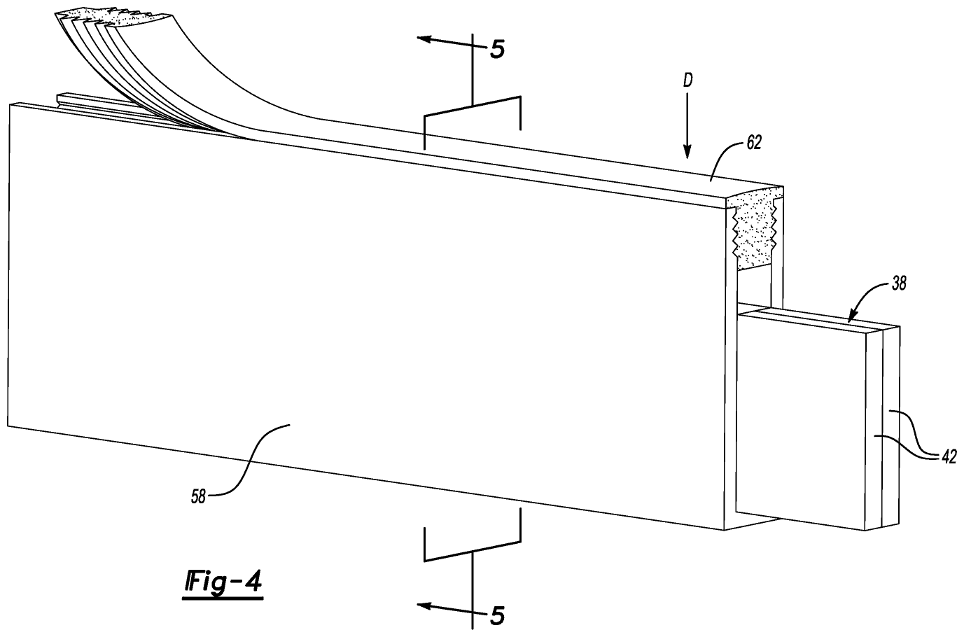

With reference to FIG. 6, the plug 62 has an inserted portion 74 that is configured to be received within the channel 54 when the plug 62 is engaged with the shroud 58. The inserted portion 74 is configured to be inserted in a direction D (FIG. 4) into the channel 54 of the shroud 58 in this example.

The inserted portion 74 has a height H. The plug 62 additionally has a width W, which is the width of the inserted portion 74. In this example, a ratio of the height H to the width W of the inserted portion 74 is greater than 0.5. Exceeding the 0.5 ratio has been found to facilitate adequate resistance to compression of the walls of the shroud 58.

Features of the disclosed examples include a plug and a shroud that engage each other to protect a busbar within a traction battery pack. The plug can prevent the shroud 58 from, among other things, compressing against busbars when external loads are applied to the shroud 58.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
a shroud providing a channel that receives at least one busbar; and
a plug that engages the shroud to brace the shroud.

2. The traction battery assembly of claim 1, wherein the shroud has a U-shaped cross-sectional profile.

3. The traction battery assembly of claim 1, wherein the shroud is an extruded shroud.

4. The traction battery assembly of claim 1, wherein the shroud includes a plurality of longitudinally extending ribs configured to retain the plug.

5. The traction battery assembly of claim 1, wherein the shroud is an aluminum shroud.

6. The traction battery assembly of claim 1, wherein the shroud is disposed between a first cell stack and a second cell stack.

7. The traction battery assembly of claim 1, wherein the at least one busbar includes and electrically isolating coating.

8. The traction battery assembly of claim 1, further comprising a traction battery pack enclosure that holds the shroud and the plug.

9. The traction battery assembly of claim 8, wherein the shroud extends longitudinally in a direction aligned with a longitudinal axis of an electrified vehicle.

10. The traction battery assembly of claim 1, wherein the plug is press-fit to the shroud to engage the shroud.

11. The traction battery assembly of claim 1, wherein the plug includes a plurality of ribs configured to engage with corresponding ribs of the shroud.

12. The traction battery assembly of claim 1, wherein the plug is an extruded plug.

13. The traction battery assembly of claim 1, wherein the plug and the shroud are the same material.

14. The traction battery assembly of claim 1, wherein the plug and the shroud are both aluminum.

15. The traction battery assembly of claim 1, wherein the plug includes an inserted portion that is configured to be inserted in a direction D into the channel, wherein a ratio of a height of the inserted portion to a width of the inserted portion is greater than 0.5.

16. The traction battery assembly of claim 15, wherein the plug has a height and a width, the height corresponding to the direction D.

17. A traction battery busbar protection method, comprising:
positioning a least one busbar within a channel of shroud; and
after the positioning, bracing the shroud with a plug that engages the shroud.

18. The traction battery busbar protection method of claim 17, wherein the shroud is a U-shaped shroud.

19. The traction battery busbar protection method of claim 17, further comprising engaging the shroud by press-fitting the plug to the channel.

20. The traction battery busbar protection method of claim 17, wherein the plug is at least partially received within the channel.
